(19) United States
(12) Patent Application Publication
(10) Pub. No.: US 2015/0229903 A1
(43) Pub. Date: Aug. 13, 2015

(54) METHOD AND APPARATUS FOR CONVERTING 2D VIDEO IMAGE INTO 3D VIDEO IMAGE

(71) Applicant: Electronics and Telecommunications Research Institute, Daejeon (KR)

(72) Inventors: Hye-sun KIM, Daejeon (KR); Seung Woo NAM, Daejeon (KR); Yun Ji BAN, Daejeon (KR); Kyung Ho JANG, Daejeon (KR)

(21) Appl. No.: 14/609,876

(22) Filed: Jan. 30, 2015

(30) Foreign Application Priority Data
Feb. 11, 2014 (KR) 10-2014-0015521

(51) Int. Cl. H04N 13/00; H04N 13/04

(52) U.S. Cl. CPC H04N 13/0022; H04N 13/0025; H04N 13/0454; H04N 13/0037; H04N 13/0029; H04N 2013/0085; H04N 2013/0077

(57) ABSTRACT

An apparatus for converting a 2D video into a 3D video updates a plurality of segmentation images of a previous frame by using motion information with respect to each frame, applies depth information of each segmentation image of the previous frame to a corresponding segmentation image of a subsequent frame to create a depth map image of each frame, and creates a stereoscopic image of each frame by using the depth map image of each frame.

### CROSS-REFERENCE TO RELATED APPLICATION

This application claims priority to and the benefit of Korean Patent Application No. 10-2014-0015521 filed in the Korean Intellectual Property Office on Feb. 11, 2014, the entire contents of which are incorporated herein by reference.

### BACKGROUND OF THE INVENTION

(a) Field of the Invention

The present invention relates to a method and apparatus for converting a two-dimensional (2D) video into a 3D video, and more particularly, to a method and apparatus for converting an input continuous 2D video into a 3D stereoscopic video without user intervention.

(b) Description of the Related Art

When viewing an object, human beings can recognize depth because a left eye and a right eye deliver different images to the brain from different positions. The brain of a human being recognizes depth of an object based on a difference in phase between two images delivered through a left eye and a right eye. Thus, in creating stereoscopic content, left and right images should be created as a pair in any event.

In order to create a stereoscopic image with a camera, a method of capturing images using two cameras (left and right cameras) or a method of creating left and right images from images captured with a single camera may be used. Both methods may create high quality content but require a large amount of time and effort.

Conversely, a system for converting a monocular video into a stereoscopic video without user intervention has been developed. It is a technique appropriate for content of TVs, mobile devices, or the like, where multiple content items are required within a short time.

For stereoscopic video conversion, a method using motion parallax may be used. This method may be used when there is a motion in a horizontal direction in a sequential frame structure of video. In this method, a current frame and a subsequent frame in which an appropriate horizontal motion is captured are used as left and right images, respectively. Due to simple logic and real-time characteristics, this method is included as an internal function of a 3DTV and commercialized.

Further, a method of recognizing an amount of motion as depth information, creating a depth map, and subsequently creating left and right images has also be actively researched.

However, in case of using motion information, if a video includes a very weak motion, a 3D effect cannot be substantially created, and due to non-connectivity between motion information and a 3D effect, a completely irrelevant stereoscopic image may be created. Also, in case of a video without motion information, motion information needs to be newly created, requiring a large amount of time to convert it into a stereoscopic image.

A 3D effect may be created even with simple color information without motion information. After an image is divided into several segmentations using color values of the image, depth may be provided to each of the segmentations according to a predetermined depth deposition rule to create a 3D effect. However, a stereoscopic conversion technique using simple color information has difficulty in converting into smooth 3D because there is no connectivity between continuous frames of a video. Also, since depth values of continuous frames are set unconnectedly, a flickering phenomenon may occur.

In order to convert a 2D video into a 3D stereoscopic video, it is very important to maintain connectivity of a 3D effect such that front and rear frames can be smoothly connected, as well as supporting a rich 3D effect of an image. To this end, a technique of extracting an object from a video, continuously tracking it, and providing consistent depth information thereto is required.

A technique of extracting depth information from a 2D image using both motion information and color information of an image and creating left and right binocular images has been studied in various fields, but, in most cases, research is mainly focused on extraction of an object from an image.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for converting a 2D video into a 3D video capable of maintaining continuity of a 3D effect in a continuous video, while creating a rich 3D effect using motion information and color information of images.

An exemplary embodiment of the present invention provides a converting method of an apparatus for converting a 2D video into a 3D video. The converting method may include: creating a depth map image with respect to a first frame image, among a plurality of continuous frame images of the 2D video, by using color information of the first frame image; creating depth map images with respect to second to final frame images, among the plurality of frame images, by using motion information between a current frame image and a previous frame image with respect to each frame image; and creating a stereoscopic image by using the depth map images respectively created from the plurality of frame images.

The creating of the depth map image with respect to the first frame image may include: splitting the first frame image into a plurality of segmentation images by using color information of the image; and applying depth information to each of the plurality of segmentation images to create a depth map image with respect to the first frame image.

The creating of depth map images with respect to the second frame image to the final frame image may include: updating a plurality of segmentation images of a previous frame image by using motion information between a current frame image and the previous frame image with respect to each frame image to create a plurality of segmentation images of each frame image; and applying depth information to each of the plurality of updated segmentations of each frame image to create a depth map image with respect to each frame image.

The creating of depth map images with respect to the second frame image to the final frame image may further include extracting motion information between the current frame image and the previous frame image.

The creating of a depth map image with respect to each frame image may include applying depth information, which has been applied to the plurality of segmentations of the previous frame image, as is to a plurality of segmentations of each frame image updated from the previous frame image.

The converting method may further include correcting the plurality of segmentation images of each frame image.

The correcting may include combining a segmentation image having a size equal to or smaller than a pre-set size with a neighboring segmentation image by using color information.

The correcting may include combining pixels without motion information to a neighboring segmentation image or creating a new segmentation image.

The creating of the stereoscopic image may include shifting pixels of the depth map images respectively created from the plurality of frame images to the left or right to create left and right binocular images.

Another embodiment of the present invention provides an apparatus for converting a 2D video into a 3D video

The converting apparatus may include an image splitting unit, a depth map creating unit, and a 3D converting unit. The image splitting unit may update a plurality of segmentation images of a previous frame by using motion information with respect to each frame of the 2D video. The depth map creating unit may apply depth information of each segmentation image of the previous frame to a corresponding segmentation image of a subsequent frame to create a depth map image of each frame. The 3D converting unit may create a stereoscopic image of each frame by using the depth map image of each frame.

The image splitting unit may create a plurality of segmentation images of a first frame of the 2D video without motion information by using color information of the first frame.

The depth map creating unit may apply depth information to the plurality of segmentation images of the first frame according to a pre-set rule.

The converting apparatus may further include a motion extracting unit configured to extract the motion information by using a difference in images of a current frame and a previous frame with respect to each frame.

The image splitting unit may correct the plurality of corrected segmentation images of each frame.

### BRIEF DESCRIPTION OF THE DRAWINGS

FIG. 1 is a view schematically illustrating an apparatus for converting a 2D video into a 3D video according to an exemplary embodiment of the present invention.

FIG. 2 is a flowchart illustrating a conversion method of a conversion device according to an exemplary embodiment of the present invention.

FIG. 3 is a view illustrating a process of creating a depth map image by providing depth values to segmentations divided using color information of an image.

FIG. 4 is a view illustrating a method for updating segmentations using motion information according to an exemplary embodiment of the present invention.

FIG. 5 is a view illustrating an example of a depth map image created from a previous frame using motion information.

FIG. 6 is a flowchart illustrating a conversion method according to another exemplary embodiment of the present invention.

FIG. 7 is a view illustrating images of segmentations of continuous frames and depth map images created according to a conversion method according to an exemplary embodiment of the present invention.

FIG. 8 is a block diagram of a conversion device according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a method and apparatus for converting a 2D video into a 3D video according to an exemplary embodiment of the present invention will be described in detail with reference to the accompanying drawings.

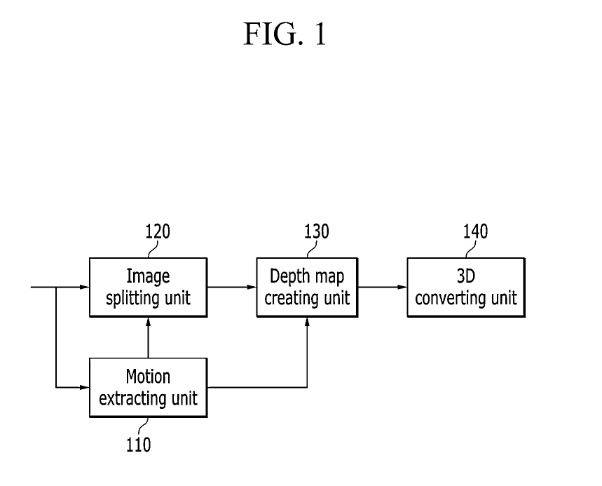

FIG. 1 is a view schematically illustrating an apparatus for converting a 2D video into a 3D video according to an exemplary embodiment of the present invention.

Referring to FIG. 1, an apparatus for converting a 2D video into a 3D video (hereinafter referred to as a “converting apparatus”) includes a motion extracting unit 110, an image splitting unit 120, a depth map creating unit 130, and a 3D converting unit 140.

The motion extracting unit 110 extracts motion information between a previous frame and a current frame in a 2D video, and delivers the motion information to the image splitting unit 120.

The image splitting unit 120 splits an image of a first frame among a plurality of continuous frames of the 2D video into a plurality of segmentations by using color information of the image. Each of the segmentations includes pixels having a similar color value. Since the color information does not include information on a homogeneous region, it is frequently used as a criterion for splitting a region.

The image splitting unit 120, starting from an image of a second frame, updates the segmentations of the previous frame by using the motion information to create images of a plurality of segmentations of each frame.

The image splitting unit 120 may correct the created images of the segmentations of the frames. For example, the image splitting unit 120 may compare color information of segmentations equal to or smaller than a predetermined size with color information of a neighboring segmentation and combine them. Also, the image splitting unit 120 may compare color information of pixels without motion information with color information of a neighboring segmentation and combine them or create a new segmentation.

The depth map creating unit 130 creates depth map images by applying depth values to the segmentations of each frame. A rule for applying a depth value may be generally set such that a lower portion of an image has a front depth value and an upper portion of the image has a rear depth value. The depth map creating unit 130 may use a depth value applied to segmentations of a previous frame as is for segmentations of a subsequent frame associated with the segmentations of the previous frame.

The 3D converting unit 140 creates left and right binocular images, namely, 3D images, of each frame by using the depth maps respectively created from the frames. The 3D converting unit 140 may create left and right binocular images by shifting pixels to the left or right based on the depth map images.

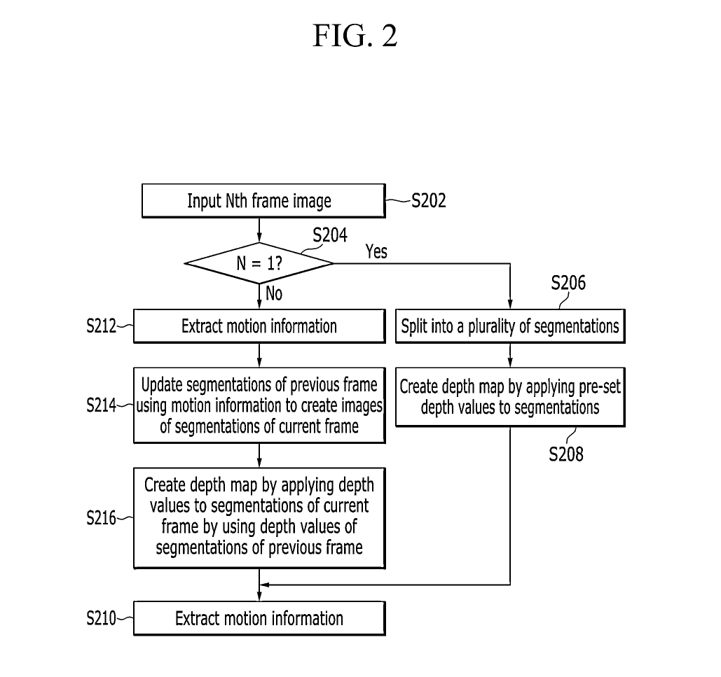

FIG. 2 is a flowchart illustrating a conversion method of a conversion device according to an exemplary embodiment of the present invention.

Referring to FIG. 2, images of continuous frames of a video are input to the motion extracting unit 110 and the image splitting unit 120.

When an image of an Nth frame is input (S202), the image splitting unit 120 and the motion extracting unit 110 determine whether the input frame is a first frame. That is, the image splitting unit 120 and the motion extracting unit 110 determine whether N is 1 (N=1) (S204).

In case of N=1, a previous frame does not exist, and thus there is no motion information. In case of N=1, because the motion information does not exist, the image splitting unit 120 splits an image of the first frame into a plurality of segmentations by using only color information (S206).

The depth map creating unit 130 creates a depth map image of the first frame by applying a depth value to the segmentations of the first frame (S208).

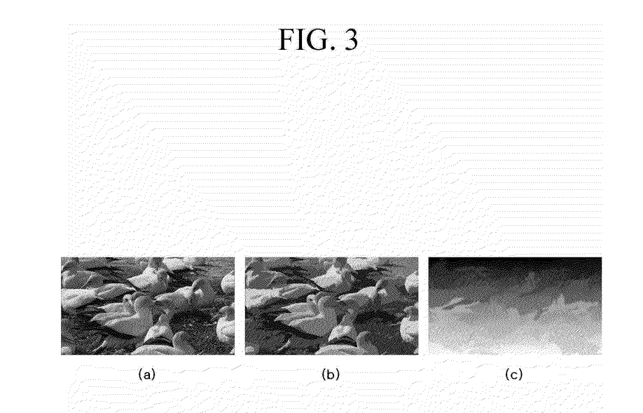

FIG. 3 is a view illustrating a process of creating a depth map image by providing depth values to segmentations divided using color information of an image.

For example, it is assumed that an image of the first frame is such as shown in (a) of FIG. 3. The image splitting unit 120 may split only color information of the image into a plurality of segmentations, and the depth map creating unit 130 may subsequently apply an appropriate depth value to each of the segmentations to create a depth map image as illustrated in (c) of FIG. 3.

Referring back to FIG. 2, the 3D converting unit 140 creates left and right binocular images by using the depth map image of the first frame (S210).

Meanwhile, when N is not 1 (S202), a previous frame exists. When N is not 1 (i.e., N=2), the motion extracting unit 110 extracts motion information between an image of a second frame and the image of the previous frame (S212) and delivers the motion information to the image splitting unit 120. For example, the motion extracting unit 110 may search for a matching point between the previous frame and the current frame by using a block matching algorithm to extract motion information of corresponding pixels from the previous frame to the current frame. The extracted motion information may be used to update images of the segmentations of the previous frame.

The image splitting unit 120 checks the segmentations of the previous frame by using the motion information, and updates the segmentations of the previous frame to create an image of the segmentations of the second frame (S214)

In the case of using the motion information, in which of segmentations of the previous frame a certain pixel of the current frame is included can be checked, and thus, updating can be performed while maintaining the information of the corresponding segmentation. Information of the segmentations may include a distribution and depth values of the segmentations.

The depth map creating unit 30 checks depth values applied to the segmentations of the previous frame by using the motion information, and apply depth values to the segmentations of the second frame by using the depth values applied to the plurality of segmentations of the previous frame to create a depth map image of the second frame (S216). The depth map creating unit 130 applies the corresponding depth values, which have been applied to the plurality of segmentations of the previous frame, as is to the plurality of segmentations of the second frame, respectively, to create a depth map image of the second frame. In this manner, since the depth values of the segmentations of the first frame are associated with the segmentations of the second frame, stereoscopic continuity between the front and rear frames can be maintained.

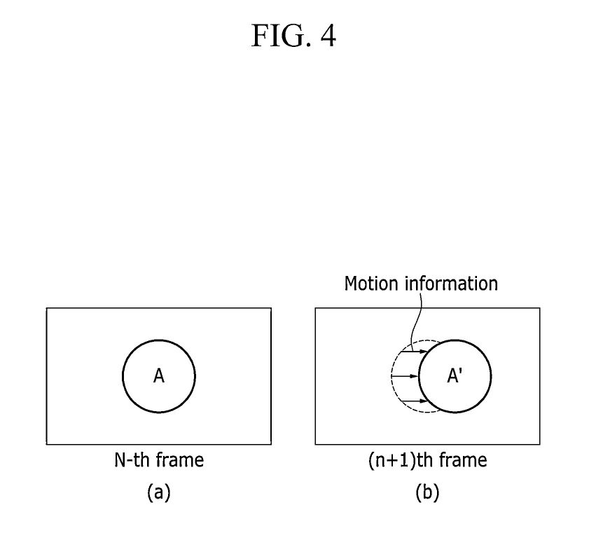

FIG. 4 is a view illustrating a method for updating segmentations using motion information according to an exemplary embodiment of the present invention.

For example, it is assumed that an image of a first frame is such as shown in (a) of FIG. 4. The motion extracting unit 110 extracts motion information between an image of a second frame and an image of a first frame. Next, the image splitting unit 120 may check information of a segmentation A of a previous frame and update the segmentation (A) of the first frame to create a segmentation A′ of the second frame. The depth map creating unit 130 may apply a depth value, which has been applied to the segmentation A, as is to the segmentation A′ of the second frame to create a depth map image of the second frame.

Referring back to FIG. 2, the 3D converting unit 140 creates left and right binocular images using the depth map image of the second frame (S210).

For images from a third frame to a final frame of the plurality of continuous frames of the video, depth map images may be created by using motion information and left and right binocular images may be created by using the created depth map images of the frames in the same manner as that of the method of creating the depth map image of the second frame.

In this manner, according to the converting method of the exemplary embodiment of the present invention, images of segmentations of a previous frame are updated by using motion information in each frame of a video, and depth values of segmentations of the previous frame are associated with segmentations of a subsequent frame to create a depth map image. Accordingly, a rich 3D effect of an image can be obtained and continuity of the 3D effect can be maintained such that front and rear frames are smoothly connected.

Meanwhile, when motion information is extracted from the motion extracting unit 110, a matching point of a previous frame may not be searched over every pixel of a current frame. A pixel part in which mobility information has failed to be searched may be expressed in black, and noise of motion information is generated frequently when there is a large amount of motion in an image and color information of the image is not diverse.

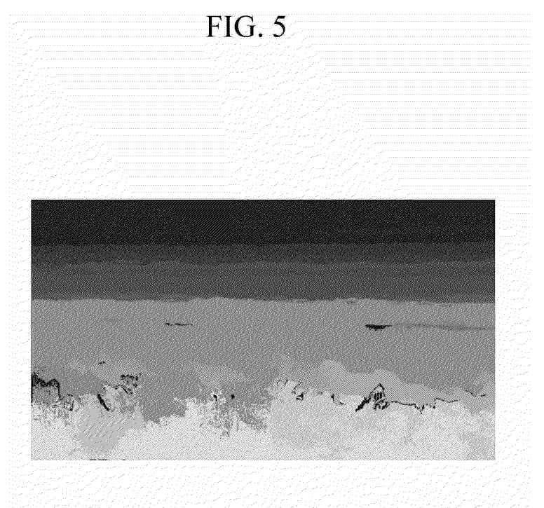

FIG. 5 is a view illustrating an example of a depth map image created from a previous frame using motion information.

As illustrated in FIG. 5, it can be seen that pixel parts where mobility information has failed to be searched are expressed in black and the boundaries of the segmentations are broken down due to noise of the mobility information. Such an error is accumulated as calculation of continuous frames of the video continues, to end up with a greater error.

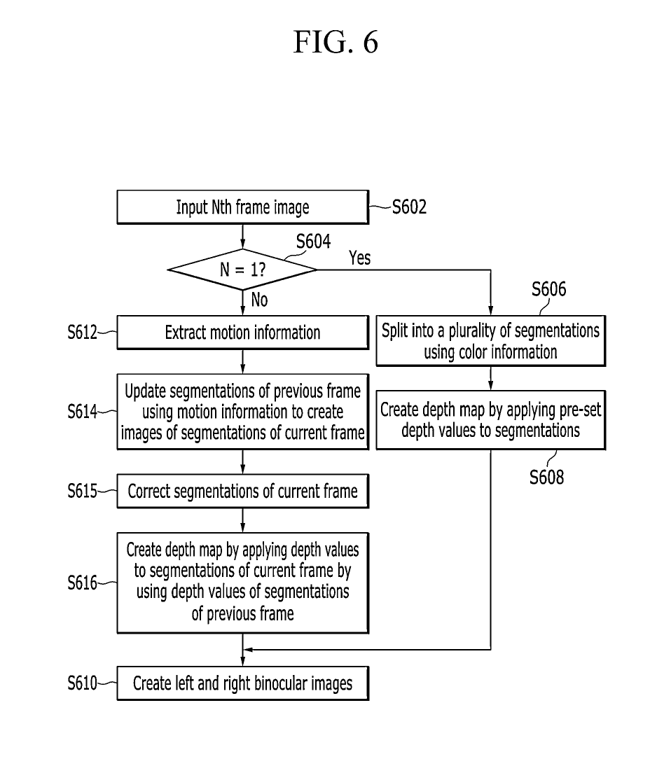

Thus, although a depth map may be immediately created from a previous frame by using motion information, the problem due to noise of mobility information cannot be solved. Thus, a converting method addressing the problem will be described in detail with reference to FIG. 6.

FIG. 6 is a flowchart illustrating a conversion method according to another exemplary embodiment of the present invention.

Referring to FIG. 6, images of continuous frames of a video are input to the motion extracting unit 110 and the image splitting unit 120.

When an image of an Nth frame is input (S602), the image splitting unit 120 and the motion extracting unit 110 determine whether N is 1 (N=1) (S604).

When N is 1, the image splitting unit 120 creates a depth map image of a first frame using only color information of the image in the same manner as that of the methods (S204 to S208) of FIGS. 2 (S604 to S608), and creates left and right binocular images using the depth map image of the first frame (S610).

Meanwhile, when N is not 1 (S602), images of segmentations of frames are created upon being updated from previous frames using motion information in the same manner as that of the methods (S212 and S214) described above with reference to FIG. 2 (S612 and S614). Here, the images of the segmentations may have such a problem as in FIG. 5. However, since the images of the segmentations have more information than that of the depth map image, images can be corrected.

The image splitting unit 120 creates images of segmentations of a current frame from images of segmentations of a previous frame and subsequently corrects the images of the segmentations of the current frame using the motion information (S615). The image splitting unit 120 may compare color information of pixels without motion information in the current frame with color information of a neighboring segmentation and combine them into a single segmentation or may create a new segmentation. The image splitting unit 120 may compare color information of segmentations having a size equal to or smaller than a predetermined size with color information of a neighboring segmentation and combine them into a single segmentation. Through the image correction process, an error due to noise of motion information can be corrected.

Thereafter, depth values may be applied to the corrected images of the fragmentations of each frame using the depth values applied to a plurality of segmentations of the previous frame, to thus create a depth map image (S616).

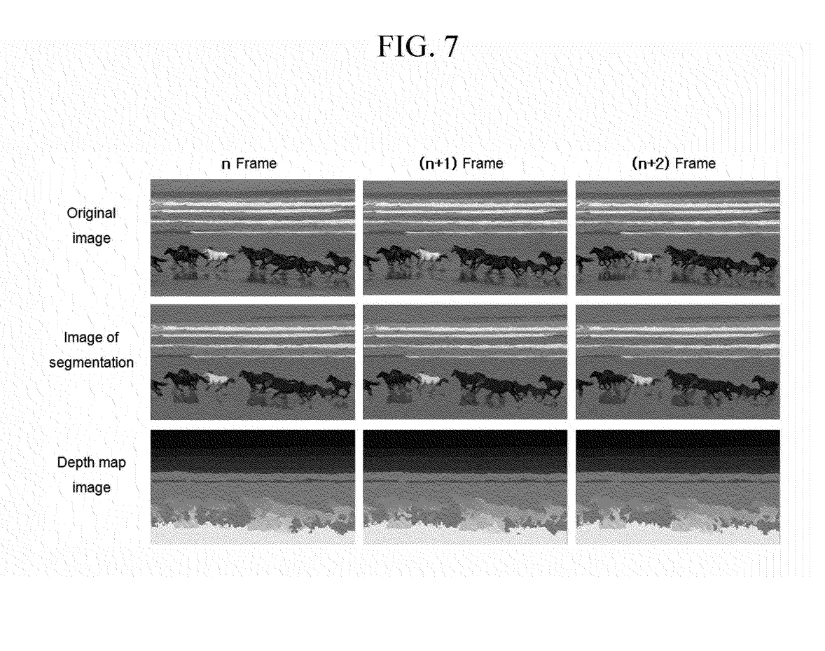

FIG. 7 is a view illustrating images of segmentations of continuous frames and depth map images created according to a conversion method according to an exemplary embodiment of the present invention.

As illustrated in FIG. 7, it can be seen that, when the converting method according to an exemplary embodiment of the present invention is used, images of segmentations and a depth map image can be updated in each frame of a video, while maintaining continuity of the frames.

Meanwhile, a depth map may be immediately created from a previous frame by using motion information. In this case, however, a problem due to noise of the motion information cannot be solved. That is, an algorithm used to extract motion information may fail to properly discover a matching point of a previous frame all the time. When there is a large amount of motion in an image and color information of the image is not diverse, noise of motion information occurs frequently.

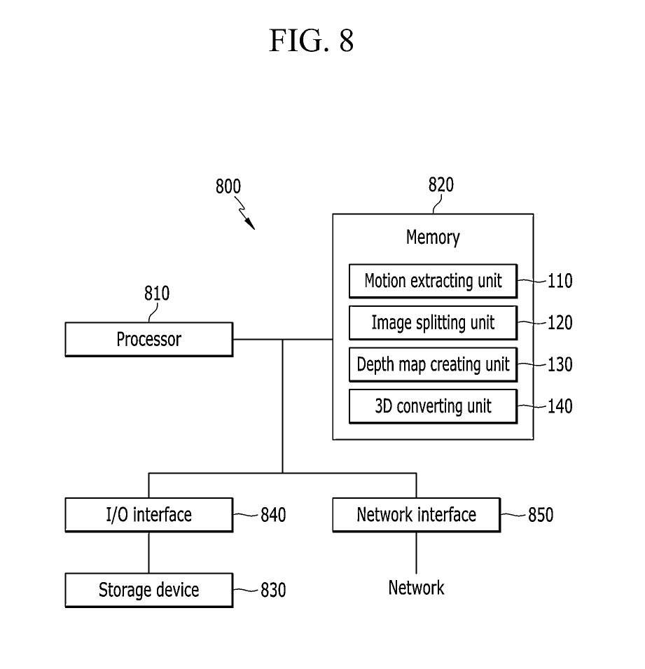

At least some of the functions of the converting method and apparatus according to the exemplary embodiment of the present invention as described above may be implemented by hardware or may be implemented by software combined with hardware. Hereinafter, an exemplary embodiment in which the converting apparatus and method are combined with a computer system will be described in detail with reference to FIG. 8.

FIG. 8 is a block diagram of a conversion device according to another exemplary embodiment of the present invention, which shows a system that may be used to perform at least some of the functions of the motion extracting unit 110, the image splitting unit 120, the depth map creating unit 130, and the 3D converting unit 140 described above with reference to FIGS. 1 through 7.

Referring to FIG. 8, a converting apparatus 800 includes a processor 810, a memory 820, at least one storage device 830, an input/output (I/O) interface 840, and a network interface 850.

The processor 810 may be implemented as a central processing unit (CPU), any other chip sets, a microprocessor, or the like, and the memory 820 may be implemented as a medium such as a RAM including a dynamic random access memory (DRAM), a rambus DRAM (RDRAM), a synchronous DRAM (SDRAM), a static RAM (SRAM), or the like. The storage device 830 may be implemented as a permanent or volatile storage device, such as a hard disk, a compact disk read only memory (CD-ROM), a CD rewritable (CD-RW), a digital video disk ROM (DVD-ROM), a DVD-RAM, a DVD-RW disk, a blue-ray disk, or the like, flash memories, or various types of RAMs. The I/O interface 840 enables the processor 810 and/or the memory 820 to access the storage device 830, and the network interface 850 enables the processor 810 and/or the memory 820 to access a network.

In this case, the processor 810 may load a program command for implementing at least some of functions of the motion extracting unit 110, the image splitting unit 120, the depth map creating unit 130, and the 3D converting unit 140 to the memory 820 to provide control to perform the operations described above with reference to FIGS. 1 through 7. The program command may be stored in the storage device 830 or may be stored in a different system connected via a network.

The processor 810, the memory 820, the storage device 830, the I/O interface 840, and the network interface 850 illustrated in FIG. 8 may be implemented in a single computer or may be implemented in a plurality of computers in a distributed fashion.

According to exemplary embodiments of the present invention, since a monocular 2D video is converted into a 3D stereoscopic video using color information and motion information together, a rich 3D effect can be obtained and continuity of frames can be guaranteed.

In particular, since images of segmentations of each frame are created and a depth map is created using the created images, a rich 3D effect can be expressed, and since images of segmentations are updated using motion information such that continuity of frames is supported, continuity and stability of a stereoscopic image can be guaranteed. Also, noise of motion information may be corrected by correcting images of segmentation blocks.

The embodiments of the present invention may not necessarily be implemented only through the foregoing devices and methods, but may also be implemented through a program for realizing functions corresponding to the configurations of the embodiments of the present invention, a recording medium including the program, or the like, and such implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A converting method of an apparatus for converting a 2D video into a 3D video, the converting method comprising:
creating a depth map image with respect to a first frame image, among a plurality of continuous frame images of the 2D video, by using color information of the first frame image;
creating depth map images with respect to second to final frame images, among the plurality of frame images, by using motion information between a current frame image and a previous frame image with respect to each frame image; and
creating a stereoscopic image by using the depth map images respectively created from the plurality of frame images.

2. The converting method of claim 1, wherein the creating of the depth map image with respect to the first frame image comprises:
splitting the first frame image into a plurality of segmentation images by using color information of the image; and
applying depth information to each of the plurality of segmentation images to create a depth map image with respect to the first frame image.

3. The converting method of claim 2, wherein the creating of depth map images with respect to the second frame image to the final frame image comprises:
updating a plurality of segmentation images of a previous frame image by using motion information between a current frame image and the previous frame image with respect to each frame image to create a plurality of segmentation images of each frame image; and
applying depth information to each of the plurality of updated segmentations of each frame image to create a depth map image with respect to each frame image.

4. The converting method of claim 3, wherein the creating of depth map images with respect to the second frame image to the final frame image further comprises extracting motion information between the current frame image and the previous frame image.

5. The converting method of claim 3, wherein the creating of a depth map image with respect to each frame image comprises applying the depth information, which has been applied to the plurality of segmentations of the previous frame image, as is to a plurality of segmentations of each frame image updated from the previous frame image.

6. The converting method of claim 3, further comprising correcting the plurality of segmentation images of each frame image.

7. The converting method of claim 6, wherein the correcting comprises combining a segmentation image having a size equal to or smaller than a pre-set size with a neighboring segmentation image by using color information.

8. The converting method of claim 6, wherein the correcting comprises combining pixels without motion information to a neighboring segmentation image or creating a new segmentation image.

9. The converting method of claim 1, wherein the creating of the stereoscopic image comprises shifting pixels of the depth map images respectively created from the plurality of frame images to the left or right to create left and right binocular images.

10. An apparatus for converting a 2D video into a 3D video, the apparatus comprising:
an image splitting unit configured to update a plurality of segmentation images of a previous frame by using motion information with respect to each frame of the 2D video;
a depth map creating unit configured to apply depth information of each segmentation image of the previous frame to a corresponding segmentation image of a subsequent frame to create a depth map image of each frame; and
a 3D converting unit configured to create a stereoscopic image of each frame by using the depth map image of each frame.

11. The apparatus of claim 10, wherein the image splitting unit creates a plurality of segmentation images of a first frame of the 2D video without motion information by using color information of the first frame.

12. The apparatus of claim 11, wherein the depth map creating unit applies depth information to the plurality of segmentation images of the first frame according to a pre-set rule.

13. The apparatus of claim 10, further comprising
a motion extracting unit configured to extract the motion information by using a difference in images of a current frame and a previous frame with respect to each frame.

14. The apparatus of claim 10, wherein the image splitting unit corrects the plurality of corrected segmentation images of each frame.

15. The apparatus of claim 14, wherein the image splitting unit combines a segmentation image having a size equal to or smaller than a pre-set size with a neighboring segmentation image by using color information.

16. The apparatus of claim 14, wherein the image splitting unit combines pixels without motion information to a neighboring segmentation image or creates a new segmentation image.

17. The apparatus of claim 10, wherein the 3D converting unit shifts the depth map image of each frame to the left or right to create left and right binocular images.
